(19) United States
(12) Patent Application Publication
(10) Pub. No.: US 2013/0265345 A1
(43) Pub. Date: Oct. 10, 2013

(54) Adjusting Liquid Crystal Display Voltage Drive for Flicker Compensation

(71) Applicant: Scott A. Krig, Santa Clara, CA (US)

(72) Inventor: Scott A. Krig, Santa Clara, CA (US)

(21) Appl. No.: 13/994,721

(22) PCT Filed: Oct. 10, 2011
(86) PCT No.: PCT/US11/55603

§ 371 Date: Jun. 15, 2013

(51) Int. Cl. G09G 3/36

(52) U.S. Cl. CPC G09G 3/36
USPC 345/690; 345/87

(57) ABSTRACT

Liquid crystal display flicker may be controlled by adjusting the positive and negative drive signals differently in one embodiment. Moreover, the drive signals may be adjusted per pixel to an extent dependent on the intensity of the pixel.

### BACKGROUND

This relates generally to liquid crystal displays.

Liquid crystal displays are made up of an array of pixels. Each pixel is driven by a drive signal that alternates between a positive and a negative level. A variety of patterns of drive signals are known for driving pixel arrays in liquid crystal displays. However, with most common liquid crystal displays, flicker occurs under various circumstances.

Flicker is the appearance that the image is oscillating or shaking. For many users, flicker is extremely annoying and quite distracting.

### BRIEF DESCRIPTION OF THE DRAWINGS

FIG. 1 is a schematic depiction of a liquid crystal display in accordance with one embodiment of the present invention;

FIG. 2 is a flow chart for one embodiment of the present invention; and

FIG. 3 is a flow chart for another embodiment of the present invention.

### DETAILED DESCRIPTION

In accordance with some embodiments, flicker may be compensated by adjusting the positive and negative pixel drive signals independently. In some cases, automated systems may be used to detect and compensate for flicker.

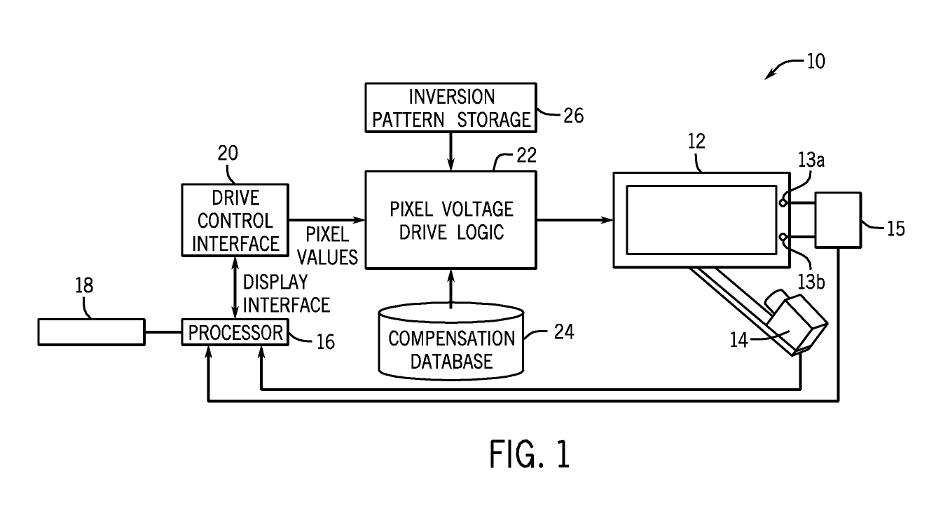

Referring to FIG. 1, a display 10 may be any liquid crystal display, including a display used for a computer monitor, television displays, and displays for handheld devices, such as cellular telephones, tablet computers, laptop computers, mobile Internet devices, and gaming devices.

The display 12 may include flicker controls 13a and 13b. The control 13a may be used to adjust the positive pixel drive signal and the control 13b may be used to adjust the negative pixel drive signal. Rotating the rotary control 13a or b to the right may increase the drive signal and rotating the rotary control 13a or b to the left may decrease the drive signal. For example, the voltage level of the signal may be increased or decreased. While, of course, there may be a linear correspondence between the extent of rotation of the control and the extent of correction, in many embodiments, non-linear relationships may be used, including the use of a gamma curve based correction.

While a mechanical system is shown, the same thing can be implemented by a graphical user interface on the display. In addition, while rotary controls are illustrated, other controls may also be used, including sliding input devices.

In some embodiments, it is advantageous that the positive and negative drive signals can be adjusted independently. In some cases, the negative signals may tend to overshoot more than the positive signals and, thus, different corrections may be advantageous in the positive and negative drive signals.

In addition, in some embodiments, a video camera 14 may be provided to actually image the display shown on the screen 12. For example, the camera 14 may capture images at a much higher frame rate than the images are displayed by the screen 12. Thus, high frequency motion may be detected that may correspond to flicker. If successive frames captured by the camera 14 are subtracted, one can get a measure of the extent of flicker. In one embodiment, if the measure indicates that the flicker is below a threshold, the corrective action may be deemed successful and, otherwise, additional corrective action may be taken.

The camera 14 and the controls 13 may be coupled to a processor 16. The controls 13 may be coupled to an interface 15 that converts the control signals into digital signals indicative of the extent of correction.

The processor 16 may be coupled to a storage 18. It may also be coupled by a display interface to a drive control interface 20. The drive control interface 20 may be useful in selecting the type of inversion pattern that may be used. Generally, different inversion patterns may be stored in the inversion pattern storage 26. Known inversion patterns include frame inversion, in which the inversion changes from frame to frame, column inversion, in which the inversion is different across different red, blue, and green color stripes or columns, row inversion, in which successive rows are different polarities, and pixel or dot inversion, in which the inversion pattern is on a pixel basis.

In some embodiments, different inversion patterns may be used to attempt to overcome flicker in different circumstances. The nature and extent of the flicker may be dependent on the nature of the images being displayed. For example, flicker may be more pronounced in connection with video gaming applications. Thus, one correction that may be applied would be to change the inversion pattern.

The inversion pattern storage and a compensation database 24 to adjust each voltage level according to a compensation function may be coupled to a pixel voltage drive logic 22 that receives pixel values from the drive control interface 20. In one embodiment, the database 24 may hold a lookup table (LUT). In another embodiment, a neural net may be used. The pixel voltage drive logic 22 converts the pixel values into drive voltages that may be used to compensate for flicker in one embodiment. The drive signals may be applied to red, green, and blue pixel stripes in conventional liquid crystal display technology. Ultimately, the corrected signals are then driven to the display screen 12.

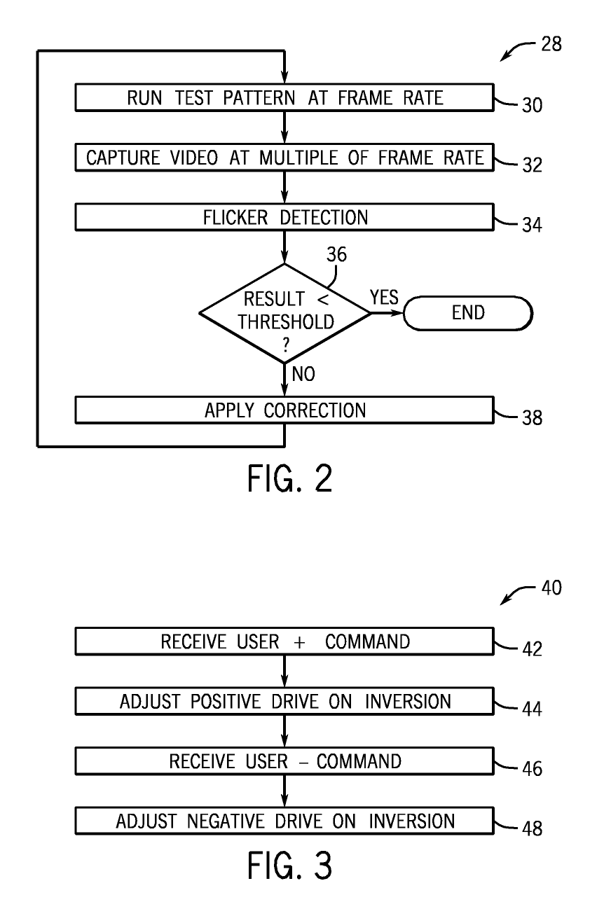

Referring to FIG. 2, in accordance with an automated technique for flicker compensation which, in some embodiments, may be implemented in the display factory, a sequence 28 may be implemented in software, hardware, and/or firmware. The sequence may be implemented by computer executable instructions stored on a non-transitory computer readable medium, such as an optical, magnetic, or semiconductor storage. One such storage may be the storage 18, coupled to the processor 16. Other potential storages include storage associated with the drive logic 22.

In accordance with one embodiment, a test pattern may be run at the frame rate of the display, as indicated in block 30. A variety of test patterns are known and specific test patterns are known to create flicker under different circumstances. One such set of test patterns is available on the Internet at logon.nl/led/test/inversion.php. Other test patterns may be used for specific circumstances.

Next, the video action being displayed as a result of the test pattern or other test image may then be captured (block 32) by the camera 14 at a higher frame rate than the display frame rate, such as a multiple of the display frame rate. As a result, flicker may be detected, for example, by doing image subtraction of successive frames, as indicated in block 34. Other flicker detection techniques may also be used, including comparison of displayed images to stored test images and use of image heuristics calculated across regions of the display to locate anomalies. Then, a check at diamond 36 determines whether the result of multiple subtractions is less than a threshold. If so, the compensation may be deemed successful or unneeded if no compensation has already been applied and the flow may end.

Otherwise, a correction may be applied, as indicated in block 38. The correction may be to provide an increase or decrease in the positive and negative drive signals. The increase may be applied progressively by gradually increasing or decreasing the drive or a variety of different patterns may be stored in lookup tables. Generally, it may be desirable to apply the correction differently to different pixels, depending on the intensity of the displayed pixel value. The higher the drive signal and the higher the intensity on a particular pixel, the more likely is the occurrence of flicker. Thus, more correction may be applied to pixels at higher drive voltages and less correction may be applied to pixels at lower drive voltages. Linear or percentage based corrections may be applied in some embodiments. In other embodiments, non-linear corrections, such as gamma curve corrections, may be used. Again, different corrections may be applied to the positive and negative signals.

In addition to changing the amplitude of the drive voltages of both the positive and negative directions, the inversion pattern may also be changed by selecting different inversion patterns from the inversion storage 26. Available inversion patterns may be tried successively or based on the extent of the inversions, particular inversion patterns may be selected.

Referring to FIG. 3, in accordance with a more manual embodiment, a sequence 40 may be implemented in software, firmware, and/or hardware. In software and firmware embodiments, the sequence may be implemented by computer readable instructions stored on a non-transitory computer readable medium, such as a semiconductor, optical, or magnetic storage. For example, the instructions may be stored in association with the storage 18, in one embodiment.

Initially, a user command may be received from the control 13a for the position inversion signals at block 42. Then the positive drive may be adjusted, as indicated in block 44. Again, the extent of the correction need not be the same for each pixel. Different pixels being driven at different levels may be adjusted differently. Then a signal may be received for the negative inversion levels at block 46 and the appropriate correction may be applied at block 48. The correction may be applied successively until the consumer or checker is satisfied with the correction.

In some cases, interactive calibration and adjustments may be used to create values stored in lookup tables for the compensation. A software application may provide interactive controls for the user to adjust the red, green, and blue compensation values in the lookup table for each of the positive and negative voltage drives to optimize for a test image or other viewing experience, such as a video game, document, or whatever. Any image or image sequence, such as a media or game or test image, may be selected by the user for reference.

As another alternative, preset stored correction values may be provided in lookup tables. This method may allow specific sets of inversion patterns to be saved as presets for positive and negative voltage drives to optimize for a given viewing experience, such as gaming, document viewing, or Internet surfing, to mention a few examples.

Automated selection application of lookup table presets may also be used. Any number of preset values for positive and negative voltage drives may be created and stored to optimize a wide range of viewing experiences, enabling automatic selection of appropriate presets based on the image being displayed, and providing improved viewing experience over a range of images, in some embodiments.

As still another option, default and manual application of lookup table presets may be used. The user may select a specific lookup table for positive and negative voltage drives from a selection of preset lookup table values as a default value. Also, software may be provided to allow a user to interactively toggle through a list of preset lookup table values to see which values give the best viewing experience.

Of course, factory calibration may also be done according to some embodiments, as illustrated in FIG. 1.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
independently electronically adjusting positive and negative drive signals on pixels of a liquid crystal display to correct for flicker.

2. The method of claim 1 including adjusting the positive drive signals differently from the negative drive signals.

3. The method of claim 1 including adjusting the drive signals on different pixels differently.

4. The method of claim 3 including adjusting the drive signals in relation to pixel intensity.

5. The method of claim 1 including automatically obtaining a measure of the extent of flicker.

6. The method of claim 5 including capturing a video of the display to determine the extent of flicker.

7. The method of claim 6 including subtracting successive frames to determine the extent of flicker.

8. The method of claim 1 including maintaining a lookup table of drive signal correction values for said display.

9. The method of claim 1 including changing the inversion pattern to correct flicker.

10. The method of claim 1 including modifying said drive signals, analyzing the extent of flicker after modifying the drive signals, and further modifying the drive signals if the extent of the flicker exceeds a threshold.

11. A non-transitory computer readable medium storing instructions to enable a computer to:
adjust the positive and negative drive signals of pixels of a liquid crystal display independently to correct for flicker.

12. The medium of claim 11 further storing instructions to adjust the positive drive signals differently from the negative drive signals.

13. The medium of claim 11 further storing instructions to adjust the drive signals on different pixels differently.

14. The medium of claim 13 further storing instructions to adjust the drive signals in relation to pixel intensity.

15. The medium of claim 11 further storing instructions to obtain a measure of the extent of flicker.

16. The medium of claim 15 further storing instructions to capture a video of the display to determine the extent of flicker.

17. The medium of claim 16 further storing instructions to subtract successive frames to determine the extent of flicker.

18. The medium of claim 11 further storing instructions to maintain a lookup table of drive signal correction values for said display.

19. The medium of claim 11 further storing instructions to change the inversion pattern to correct flicker.

20. The medium of claim 11 further storing instructions to modify said drive signals, analyze the extent of flicker after modifying the drive signals, and further modify the drive signals if the extent of flicker exceeds a threshold.

21. An apparatus comprising:
drive logic to independently adjust positive and negative liquid crystal display drive signals for flicker; and
a processor coupled to said drive logic.

22. The apparatus of claim 21 including a liquid crystal display coupled to said drive logic.

23. The apparatus of claim 21 including an inversion pattern storage coupled to said drive logic.

24. The apparatus of claim 21 including a compensation database coupled to said drive logic.

25. The apparatus of claim 24 wherein said compensation database includes a lookup table.

26. The apparatus of claim 21, said drive logic to adjust the positive drive signals differently from the negative drive signals.

27. The apparatus of claim 21, said drive logic to adjust the drive signals to different pixels differently.

28. The apparatus of claim 27, said drive logic to adjust the drive signals in relation to pixel intensity.

29. The apparatus of claim 21, said apparatus to automatically obtain a measure of the extent of flicker.

30. The apparatus of claim 29, said apparatus to determine whether the measure exceeds a threshold.
